(19) United States
(12) Patent Application Publication
(10) Pub. No.: US 2011/0265311 A1
(43) Pub. Date: Nov. 3, 2011

(54) WORKPIECE HOLDING METHOD

(75) Inventors: Toshiyuki Kondo, Hagagun (JP); Shinji Sawada, Hagagun (JP); Nobuhiro Nanba, Hagagun (JP)

(73) Assignee: HONDA MOTOR CO., LTD., Tokyo (JP)

(21) Appl. No.: 13/089,572

(22) Filed: Apr. 19, 2011

(30) Foreign Application Priority Data
Apr. 28, 2010 (JP) 2010-103102

(51) Int. Cl. B23Q 7/04

(52) U.S. Cl. 29/559

(57) ABSTRACT

It is an object of the present invention to provide a workpiece holding method which enables a workpiece to be held when a multi-fingered hand is used to grasp the workpiece that is in an untidy heap, even if a target workpiece is subject to interference from another workpiece, and thereby the method enhances the success rate for holding the workpiece. A workpiece holding method, when two holding devices (first to fourth fingers F1 to F4) are used to hold a workpiece (reinforcement W), including a unilateral holding process of inserting a first holding device (the first finger F1 and the second finger F2) at one holding device insert position (region A) to hold and lift a workpiece-to-be-held (reinforcement-to-be-held T) in a state where the workpiece-to-be-held has no interference from any other workpieces at the region A, and a bilateral holding process of inserting a second holding device (the third finger F3 and the fourth finger F4) around (region D) the workpiece-to-be-held lifted by the first holding device, to hold the workpiece-to-be-held.

This application is based on and claims the benefit of priority from Japanese Patent Application No. 2010-103102 filed on Apr. 28, 2010, the content of which is incorporated herein by reference.

### BACKGROUND OF THE INVENTION

1. Field of the Invention

The present invention relates to a workpiece holding method, and more particularly to a method of holding a plurality of workpieces in an untidy heap using two holding devices.

2. Related Art

Conventionally, mechanical products such as vehicles are manufactured by assembling a number of parts. More specifically, for example, a plurality of robots are provided on a production line, a vehicle body or the like is conveyed along the production line, and a box-shaped bucket (pallet) containing workpieces (assembly parts) to be attached to the vehicle or the like are supplied to each of the robots. Each of the robots utilizes fingers of a hand provided at the end thereof to carry out an operation such as holding a workpiece in a bucket and attaching it to the vehicle body or the like conveyed on the production line, or holding respective workpieces in a plurality of buckets and setting out (hereinafter, referred to as “layout” or “to lay out”) the workpieces at predetermined positions on a workpiece supply unit in preparation for a subsequent assembly process on the vehicle body or the like.

Some workpieces such as sashes, molds, garnishings, and reinforcements have an elongated shape, and it is not always easy to hold such workpieces depending on their form or gravity center position thereof. In order to enable a robot to hold such an elongated workpiece, there is proposed a technique in which a robot hand provided with a plurality of fingers holds one part of the workpiece with a pair of fingers, and another part thereof with another pair of fingers. According to this technique, it becomes possible to stably hold various elongated workpieces although the workpieces may have different forms or gravity center positions (see Japanese Patent Application No. 2008-260110).

However, workpieces to be supplied to a robot may be contained in a bucket in a state where they are piled up in an untidy heap. When a multi-fingered hand is used to hold such workpieces piled up in an untidy heap, it is possible to stably hold a target workpiece as long as another workpiece is not piled on top of the target workpiece to be held. However, if another workpiece is piled on top of the target workpiece that is to be held, a problem may arise in that, even if one pair of the fingers can grasp the target workpiece, the other pair of the fingers may fail to grasp the target workpiece due to the interference of the other workpiece, thereby causing the target workpiece to be dropped.

### SUMMARY OF THE INVENTION

The present invention is conceived in view of the above problem, and it is an object of the present invention to provide a workpiece holding method that enables a target workpiece-to-be-held even if another workpiece is piled on top of the target workpiece, and thereby enhances the success rate for holding workpieces in an untidy heap, where a multi-fingered hand is used to hold workpieces in an untidy heap.

(1) In accordance with one aspect of the present invention, there is provided a workpiece holding method for holding a workpiece that is to be held by using two holding devices (e.g., first to fourth fingers F1 to F4, which will be described later) to hold the workpiece (e.g., reinforcement W, which will be described later) in a state in which there is no interference from another workpiece at an insert position (e.g., region A, which will be described later) of one holding device, at which the one holding device is to be inserted to hold the workpiece (e.g., reinforcement-to-be-held T, which will be described later), the method comprising:

a unilateral holding process of inserting a first holding device (e.g., first finger F1 and second finger F2, which will be described later) at the insert position of the one holding device, to hold and lift the workpiece-to-be-held; and

a bilateral holding process of inserting a second holding device (e.g., third finger F3 and fourth finger F4, which will be described later) around (e.g., region D, which will be described later) the workpiece-to-be-held lifted by the first holding device, to hold the workpiece-to-be-held.

According to aspect (1) of the invention, when two holding devices are used to hold a workpiece, in a state in which there is no interference from another workpiece at one holding device insert position where a holding device is inserted in the workpiece-to-be-held, from among a number of workpieces, first the first holding device is inserted at the one holding device insert position, the workpiece-to-be-held is grasped, and one end of the workpiece-to-be-held is lifted (unilateral holding process).

By lifting one end of the workpiece-to-be-held, an intermediate point thereof is proportionally lifted pivoting on the other end thereof. In this way, even if there has been interference from another workpiece at another holding device insert position thereof before lifting, such interference is eliminated, and there are no other workpieces that interrupt the insertion of the second holding device around the workpiece-to-be-held. In this state, it becomes possible to insert the second holding device around the workpiece-to-be-held and to hold the entire workpiece-to-be-held (bilateral holding process).

Thus, when a multi-fingered hand is used to grasp a workpiece from an untidy heap, in a state were another workpiece is piled on top of the workpiece-to-be-held, one holding device is inserted at one holding device insert position, at which the target workpiece has no interference from any other workpieces, to hold and lift the workpiece-to-be-held. In this way, the interference from the other workpiece at the other holding device insert position is eliminated. As a result, it becomes possible to hold the workpiece-to-be-held even if there has been interference from another workpiece at another holding device insert position thereof before lifting. As a result thereof, it is possible to increase the number of patterns of extracting a workpiece from among workpieces piled up in an untidy heap, and accordingly, to enhance the success rate of grasping a workpiece from among workpieces piled up in an untidy heap.

(2) In accordance with another aspect of the invention, in the workpiece holding method as described in the aforementioned aspect (1), the workpiece-to-be-held may be subject to interference from another workpiece at an insert position (e.g., region C, which will be described later) at which another holding device is inserted to hold the workpiece-to-be-held.

According to aspect (2) of the invention, when two holding devices are to hold a workpiece, in a state in which there is no interference from any other workpieces at one holding device insert position where one holding device is to be inserted, on the workpiece-to-be-held from among a number of workpieces, and there is interference from another workpiece at another holding device insert position, the first holding device is first inserted at the one holding device insert position to hold the workpiece-to-be-held, and lift one end thereof (unilateral holding process).

By lifting one end of the workpiece-to-be-held, the intermediate point thereof is proportionally lifted, pivoting on the other end thereof. With this, the interference from another workpiece at another holding device insert position thereof before lifting is eliminated, and there are no other workpieces that interrupt the insertion of the second holding device around the workpiece-to-be-held. In this state, it becomes possible to insert the second holding device around the workpiece-to-be-held and to hold the entire workpiece-to-be-held (bilateral holding process).

Thus, when a multi-fingered hand is to grasp a workpiece from an untidy heap, in a state where another workpiece is piled on top of the workpiece-to-be-held, with no interference from any other workpieces at one holding device insert position thereof, where one holding device is to be inserted, but with interference from another workpiece at another holding device insert position thereof, it is possible to grasp the workpiece-to-be-held even in such a state. Therefore, it is possible to increase the number of ways of extracting from among workpieces in an untidy heap and to enhance the success rate of grasping a workpiece in an untidy heap.

According to the present invention, when a multi-fingered hand is to grasp a workpiece in an untidy heap, it is possible to provide a workpiece holding method that enables grasping of a workpiece even if another workpiece is piled on top of the target workpiece and to enhance the success rate of grasping the workpiece in an untidy heap.

### BRIEF DESCRIPTION OF THE DRAWINGS

FIG. 1 is a schematic view of a workpiece layout system used in a workpiece holding method according to one embodiment of the present invention;

FIG. 2 is a perspective view showing a configuration of a hand of the workpiece layout system;

FIG. 3 is a block diagram showing a configuration of a control unit of the workpiece layout system;

FIG. 4 is a schematic diagram showing a configuration of a first finger control unit and a first finger of the workpiece layout system;

FIG. 5 is a flowchart of workpiece holding processing of the workpiece layout system;

FIG. 6 is a part of the flowchart of the workpiece holding processing of FIG. 5 showing flow of two step workpiece holding of the workpiece layout system;

FIG. 7A is a view showing a frame format of a state before virtually lifting a workpiece in the workpiece holding method according to one embodiment of the present invention;

FIG. 7B is a view showing a frame format of a state after virtually lifting the workpiece in the workpiece holding method according to one embodiment of the present invention; and

FIG. 8 is a set of views respectively showing a frame format of a series of actions of the workpiece holding method according to one embodiment of the present invention.

### DETAILED DESCRIPTION OF THE INVENTION

The following describes an embodiment of the present invention with reference to the drawings.

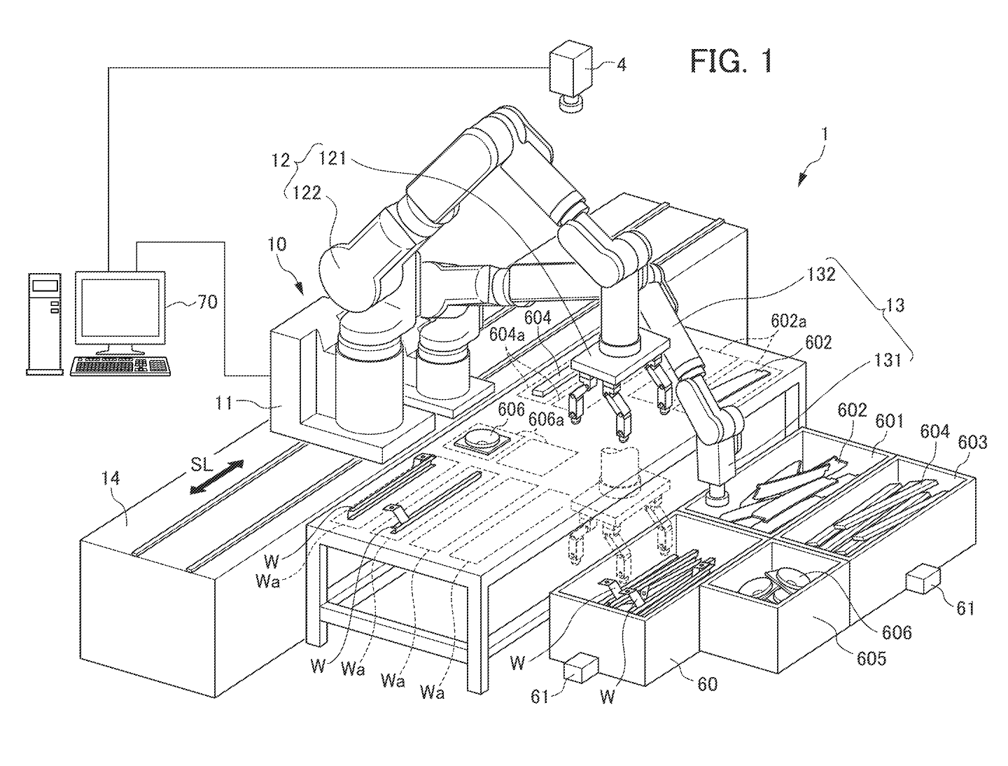

FIG. 1 is a schematic view showing a configuration of a workpiece layout system 1 as a workpiece layout system used in a workpiece holding method according to one embodiment of the present invention.

The workpiece layout system 1 is provided on a sub-assembly line that supplies a vehicle assembly line, which assembles a vehicle, with workpieces in a state (laid out state) in which a plurality of predetermined workpieces (assembly parts) are laid out at predetermined positions of a workpiece supply unit. To the workpiece layout system 1, reinforcement W, which is a workpiece, is supplied in a state in which it is contained in a bucket 60. Similarly, a workpiece 602 contained in a bucket 601, a workpiece 604 contained in a bucket 603, and a workpiece 606 contained in a bucket 605 are supplied.

The reinforcement W is of an elongated shape and is contained in an untidy heap in the bucket 60.

A kit platform 15 has a layout surface 151 where predetermined numbers of reinforcements W, and workpieces 602, 604, and 606, are to be laid out at predetermined positions. The workpiece layout system 1 holds and disposes a reinforcement W contained in the bucket 60 at a predetermined layout position Wa of the layout surface 151. Here, since it is assumed that two reinforcements W are laid out in a predetermined orientation, the process to hold and layout a reinforcement W is repeated twice. Similarly, predetermined numbers of the workpieces 602, 604, and 606 are laid out at respective predetermined layout positions 602a, 604a, and 606a. This means that the workpiece layout system 1 holds 4 kinds of workpiece, i.e., reinforcements W, and the workpieces 602, 604, and 606 from the buckets 60, 601, 603, and 605, and lays out respective predetermined numbers of the workpieces on the kit platform 15. When the layout is finished, the kit platform 15 is conveyed to the assembly line at a predetermined timing.

More specifically, the workpiece layout system 1 includes a dual armed robot 10 disposed in the vicinity of the kit platform 15, an overall image sensor 4 that senses the overall work area of the dual armed robot 10, and a control unit 70 that controls both of them. Also, the workpiece layout system 1 includes a vibrator 61 that is connected to the bucket 60 and causes the bucket 60 to vibrate if necessary.

The dual armed robot 10 includes a robot main body 11, and a first manipulator 12 as well as a second manipulator 13 as a sensing unit that are provided to the robot main body 11. The robot main body 11 may be designed to be movable on rails 14 in parallel to a linear motion axis SL.

The first manipulator 12 and the second manipulator 13 are designed to operate independently from each other.

The first manipulator 12 includes a hand 121 as a holding unit to hold a reinforcement W, and an arm 122 as a conveying unit rotatably supported by the robot main body 11 to change the posture and position of the hand 121 in a 3-dimensional space.

The second manipulator 13 includes an in-bucket workpiece image sensor 131, and an arm 132 to change the posture and position of the in-bucket workpiece image sensor 131 in a 3-dimensional space.

The in-bucket workpiece image sensor 131 photographs reinforcements W in an untidy heap contained in the supplied bucket 60 in preparation for holding of a reinforcement W. By acquiring 3-dimensional coordinate data for each pixel constituting the photographed image, and outputting, as sensing data, the 3-dimensional coordinate data thus acquired, it becomes possible to obtain a 3-dimensional positioning of each of the reinforcements W piled up in the untidy heap in the bucket 60.

The in-bucket workpiece image sensor 131 may be a sensor that measures surface form of each reinforcement W as data points based on laser triangulation by irradiating laser light on each reinforcement W and determining the precise distance between the surface thereof and the in-bucket workpiece image sensor 131 according to the laser light reflection. However, the in-bucket workpiece image sensor 131 is not limited to this and may be a sensor that employs a 3D vision system provided with two cameras, for example.

Similarly, the in-bucket workpiece image sensor 131 is moved as appropriate by the arm 132 in preparation for holding the workpieces 602, 604, and 606, and thereby is able to acquire the 3-dimensional positioning of the respective workpieces 602, 604, and 606.

According to such a configuration, it becomes possible to recognize the reinforcement W, and workpiece 602, 604, or 606 to be subsequently held, by way of the in-bucket workpiece image sensor 131, while the first manipulator 12 is holding and setting out a reinforcement W, for example, and thereby the cycle time can be reduced.

The overall image sensor 4, being provided at a position capable of viewing from above the overall workpiece area of the dual armed robot 10, photographs the dual armed robot 10, the kit platform 15 for setting out, and the buckets 60, 601, 603, and 605, acquires 3-dimensional coordinate data for each pixel constituting the photographed image, and outputs the 3-dimensional coordinate data thus acquired, as sensing data.

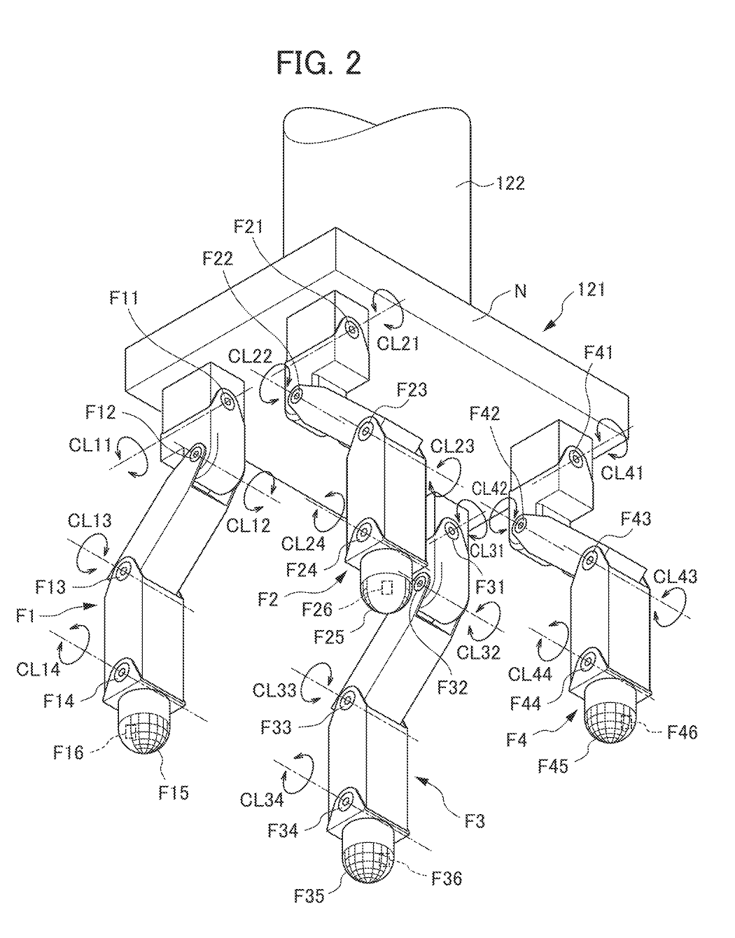

FIG. 2 is a perspective view showing a configuration of the hand 121.

The hand 121 includes a hand main body N and four fingers provided to the undersurface of the hand main body N. The four fingers include a first finger F1, a second finger F2, a third finger F3, and a fourth finger F4.

The first finger F1 and the second finger F2 constitute a pair resembling a human thumb and forefinger, and a surface F15 corresponding to a finger pad of the first finger F1 and a surface F25 corresponding to a finger pad of the second finger F2 are disposed facing each other. The adjacent third finger F3 and fourth finger F4 constitute a similar pair, and the surface F35 corresponding to a finger pad of the third finger F3 and the surface F45 corresponding to a finger pad of the fourth finger F4 are disposed facing each other.

The first finger F1, the second finger F2, the third finger F3, and the fourth finger F4 respectively have 4 joints, i.e., first to fourth joints, and are thereby configured to be capable of four-degree-of-freedom movement.

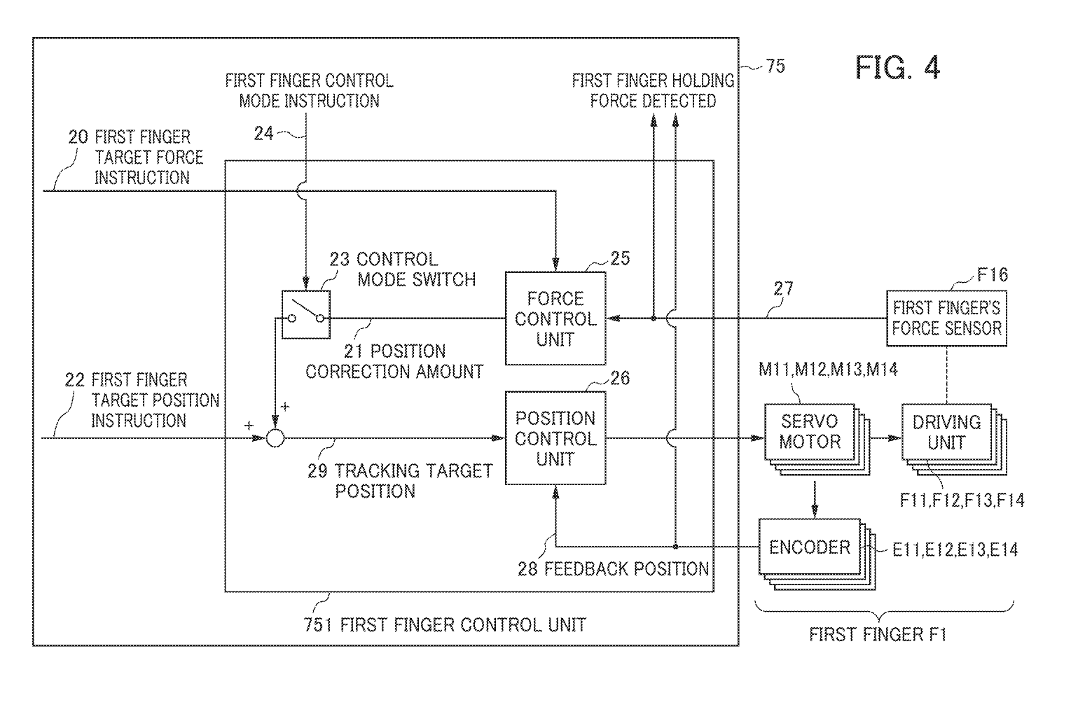

The driving unit of each joint operates by way of a servomotor (see FIG. 4), which serves as a driving source. An encoder (see FIG. 4) is connected at the output stage of each servomotor. The operation carried out by such a plurality of fingers in collaboration with one another enables a target object to hold and change the positioning of the target object while maintaining a state in which the target object is held.

Each of the joints of the first finger F1 is movable by a rotation axis thereof being driven by the driving units F11 to F14. The first joint (the base joint) of the first finger F1 rotates centering on a pitch axis CL11 by way of the driving unit F11. The second joint rotates centering on a roll axis CL12 by way of the driving unit F12, the third joint rotates centering on a roll axis CL13 by way of the driving unit F13, and the fourth joint (the tip joint) rotates centering on a roll axis CL14 by way of the driving unit F14. Therefore, the first finger F1 is configured to be capable of bending the finger tip F15 thereof, i.e., a part corresponding to the finger tip of the first finger F1, selectively in a forward direction to and in an opposite direction from the second finger F2 as well as bending the whole of the first finger F1, selectively in a forward direction to and in an opposite direction from the adjacent third finger F3.

The second finger F2 has the same configuration as the first finger F1. This means that each of the joints of the second finger F2 is movable by the rotation axis thereof being driven by the driving units F21 to F24. The first joint (the base joint) of the second finger F2 rotates centering on a pitch axis CL21 by way of the driving unit F21. The second joint rotates centering on a roll axis CL22 by way of the driving unit F22, the third joint rotates centering on a roll axis CL23 by way of the driving unit F23, and the fourth joint (the tip joint) rotates centering on a roll axis CL24 by way of the driving unit F24. Therefore, the second finger F2 is configured to be capable of bending the finger tip F25 thereof, i.e., a part thereof corresponding to a finger tip of the second finger F2, selectively in a forward direction to and in an opposite direction from the first finger F1 as well as bending the whole of the second finger F2, selectively in a forward direction to and in an opposite direction from the fourth finger F4 adjacent thereto.

Similarly, the third finger F3 has the same configuration as the first finger F1. This means that each of the joints of the third finger F3 is movable by the rotation axis thereof being driven by the driving units F31 to F34. The first joint (the base joint) of the third finger F3 rotates centering on a pitch axis CL31 by way of the driving unit F31. The second joint rotates centering on a roll axis CL32 by way of the driving unit F32, the third joint rotates centering on a roll axis CL33 by way of the driving unit F33, and the fourth joint (the tip joint) rotates centering on a roll axis CL34 by way of the driving unit F34. Therefore, the third finger F3 is configured to be capable of bending the finger tip F35 thereof, i.e., a part thereof corresponding to a finger tip of the third finger F3, selectively in a forward direction to and in an opposite direction from the fourth finger F4 as well as bending the whole of the third finger F3, selectively in a forward direction to and in an opposite direction from the first finger F1 adjacent thereto.

Similarly, the fourth finger F4 has the same configuration as the first finger F1. This means that each of the joints of the fourth finger F4 moves by the rotation axis thereof being driven by the driving units F41 to F44. The first joint (the base joint) of the third finger F4 rotates centering on a pitch axis CL41 by way of the driving unit F41. The second joint rotates centering on a roll axis CL42 by way of the driving unit F42, the third joint rotates centering on a roll axis CL43 by way of the driving unit F43, and the fourth joint (the tip joint) rotates centering on a roll axis CL44 by way of the driving unit F44. Therefore, the fourth finger F4 is configured to be capable of bending the finger tip F45 thereof, i.e., a part thereof corresponding to a finger tip of the fourth finger F4, selectively in a forward direction to and in an opposite direction from the third finger F3 in front thereof as well as bending the whole of the fourth finger F4, selectively in a forward direction to and in an opposite direction from the second finger F2 adjacent thereto.

Such a configuration enables the hand 121 to hold an elongated-shape target object such as the reinforcement W at two positions in such a manner that the first finger F1 and the second finger F2, as a pair, hold one position of the target object, and the third finger F3 and the fourth finger F4, as another pair, hold the other position of the target object.

Alternatively, the hand 121 may hold the target object in two steps such that the pair of the first finger F1 and the second finger F2 firstly hold the target object, and the pair of the third finger F3 and the fourth finger F4 secondly hold the target object. Also, the height of the two holding positions may be changed.

Furthermore, the distance between the two holding positions may be changed by tilting the pair of the first finger F1 and the second finger F2 toward the pair of the third finger F3 and the fourth finger F4 and/or by tilting the pair of the third finger F3 and the fourth finger F4 toward the pair of the first finger F1 and the second finger F2.

The finger pads F15, F25, F35, and F45 of the fingers include respective force sensors F16, F26, F36, and F46 that can sense stress imparted thereto. The finger pads F15, F25, F35, and F45 may be covered by viscoelastic members in order to stably hold a workpiece, thereby preventing the workpiece from slipping.

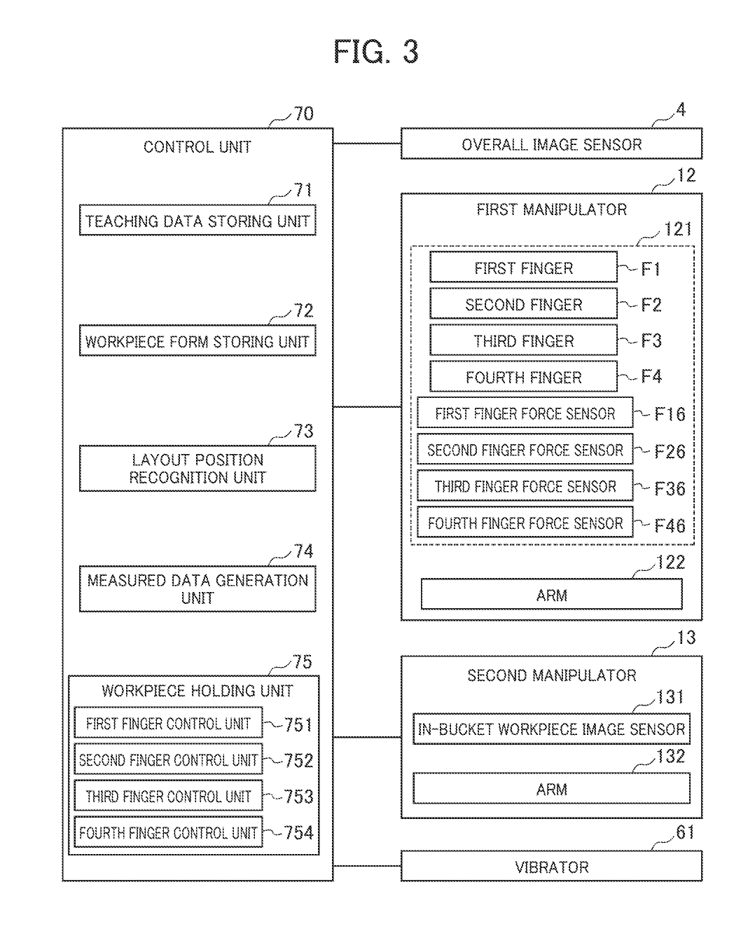

FIG. 3 is a block diagram showing a configuration of the control unit 70.

The control unit 70 includes a teaching data storing unit 71, a workpiece form storing unit 72, a layout position recognition unit 73, a measured data generation unit 74, and a workpiece holding unit 75.

The teaching data storing unit 71 stores, as teaching data, the location and positioning of a workpiece and the time, which have been taught while the workpiece is moved along a path from a time when the workpiece is held until the workpiece arrives at a predetermined layout position. Here, the path of the reinforcement W from within the bucket 60 to the predetermined layout position Wa on the kit platform 15 is stored as teaching data. Also, with respect to the workpieces 602, 604, and 606, the location and positioning of each workpiece and the time, which have been taught while each of the workpieces is moved along the path from within the buckets 601, 603, and 605 until arrival at the layout positions 602a, 604a, and 606a, are stored as teaching data.

The workpiece form storing unit 72 stores a 3-dimensional form of a target workpiece-to-be-held and set out. The layout position recognition unit 73 recognizes a layout position of a workpiece based on sensing data outputted from the overall image sensor 4. Here, a layout position of a workpiece is recognized according to the location and positioning of the layout surface 151 of the kit platform 15.

The measured data generation unit 74 controls the second manipulator 13 to cause the in-bucket workpiece image sensor 131 to photograph reinforcements W in an untidy heap contained in the supplied bucket 60 and acquires the 3-dimensional positioning of each of the reinforcements W piled up in an untidy heap in the bucket 60. Similarly, with respect to the workpieces 602, 604, and 606, it is possible to take photographs thereof and to acquire the 3-dimensional positioning of each thereof.

Furthermore, the measured data generation unit 74 controls the overall image sensor 4 to track a reinforcement W, as a workpiece, by always sensing the reinforcement W from a time when the hand 121 of the first manipulator 12 attempts to hold the reinforcement W until the reinforcement W is conveyed to the layout position Wa and generates, as measured data, the location and positioning of the workpiece at an interval of unit time by comparing the sensing data with data on a workpiece form stored in the workpiece form storing unit 72.

As described later, the workpiece holding unit 75 firstly examines which holding method is applicable to each of the reinforcements W, based on the measured data generated by the measured data generation unit 74 regarding the 3-dimensional positioning of each of the reinforcements W piled up in an untidy heap in the bucket 60, and secondly determines which holding method is to be applied to which of the reinforcements W.

The workpiece holding unit 75 includes a first finger control unit 751 that controls the first finger F1, a second finger control unit 752 that controls the second finger F2, a third finger control unit 753 that controls the third finger F3, and a fourth finger control unit 754 that controls the fourth finger F4, and thereby controls the first finger F1, the second finger F2, the third finger F3, and the fourth finger F4 in collaboration with one another to carry out an operation of holding the workpieces.

More specifically, the workpiece holding unit 75 controls the first finger F1, the second finger F2, the third finger F3, and the fourth finger F4 in collaboration with one another by way of feedback control on the driving units (see FIG. 4) of respective fingers based on the selected holding method and values output from the force sensors F16, F26, F36, and F46 at the tips of respective fingers and the encoders (see FIG. 4) of respective fingers.

Furthermore, the workpiece holding unit 75 drives the vibrator 61 as needed.

FIG. 4 is a schematic diagram showing a configuration of the first finger control unit 751 and the first finger F1.

The position control unit 26 executes position control by generating instructions to the servo motors M11, M12, M13, and M14 of the first finger F1 based on the tracking target position 29 and the feedback position 28 acquired by the encoders E11, E12, E13, and E14, which are position detectors provided to the servo motors M11, M12, M13, and M14.

On the other hand, the force control unit 25 calculates a position correction amount 21 based on a first finger target force instruction 20 and force information (magnitude and direction of force) 27 detected by the force sensor F16 provided to the tip of the first finger F1, and adds the position correction amount 21 to the first finger target position instruction 22 to acquire the aforesaid tracking target position 29. In this way, the force control unit 25 performs a force control. Here, the first finger target force instruction 20 and the first finger target position instruction 22 may be instructions sent to the workpiece holding unit 75 from an operating program of a superior apparatus (not shown) or the like that determines a manipulator operation.

Here, if the control mode switch 23 is closed so that the position correction amount 21 outputted from the force control unit 25 is added to the target position instruction 22, the first finger F1 operates by way of force control. On the other hand, if the control mode switch 23 is open, the first finger F1 operates by way of position control.

The first finger control mode instruction 24 controls the control mode switch 23 to switch between position control and force control on the first finger F1.

The second finger control unit 752 and the second finger F2, the third finger control unit 753 and the third finger F3, and the fourth finger control unit 754 and the fourth finger F4 are configured similarly to the first finger control unit 751 and the first finger F1 and can similarly switch between position control and force control on respective fingers.

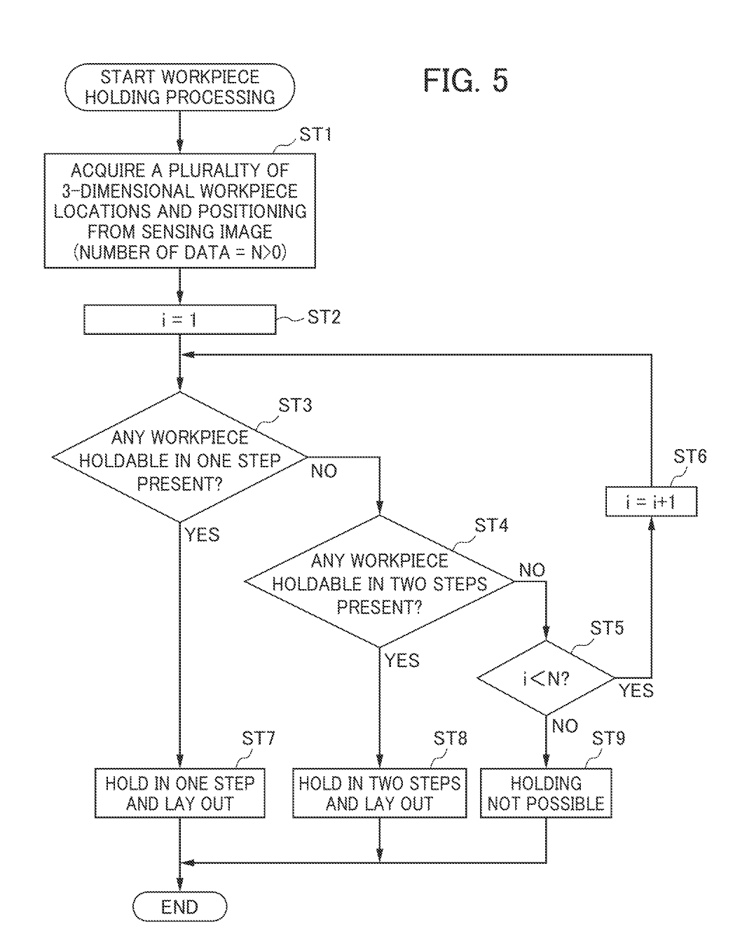

In the following, the workpiece holding operation of the workpiece layout system 1 will be described with reference to FIG. 5. FIG. 5 is a flowchart of workpiece holding processing to execute the workpiece holding operation of the workpiece layout system 1.

Here, the holding processing of the reinforcement W is assumed to be as follows: The first finger F1 and the second finger F2 hold a flange portion T1 of a reinforcement-to-be-held T, and then the third finger F3 and the fourth finger F4 hold a second holding portion T2 (intermediate point between the flange portion T1 and an opposite end portion T3).

Here, the “reinforcement-to-be-held T” is assigned in order to distinguish a probe target workpiece (a reinforcement W corresponding to a domain number i) from other reinforcements W. Therefore, if the domain number is incremented, the reinforcement-to-be-held T is reassigned to a reinforcement W corresponding to the modified domain number.

In step ST1, the workpiece holding unit 75 recognizes the 3-dimensional locations and positioning of N (>0) reinforcements W (those measurable by the in-bucket workpiece image sensor 131 from among a plurality of reinforcements W piled up in an untidy heap in the bucket 60) generated by the measured data generation unit 74 based on the output from the in-bucket workpiece image sensor 131. Here, the number of domains is assumed to be N.

In step ST2, the domain number i is initialized to be 1 (i=1).

In step ST3, it is determined whether or not one step holding is possible for the probe target workpiece corresponding to the domain number i. This is determined by whether or not both of two holding device insert positions of the holding-target workpiece, one being the position where one holding device is to be inserted and the other being the position where another holding device is to be inserted, are free of interference from any other workpieces based on data of the 3-dimensional location and positioning of N reinforcements W recognized in step ST1.

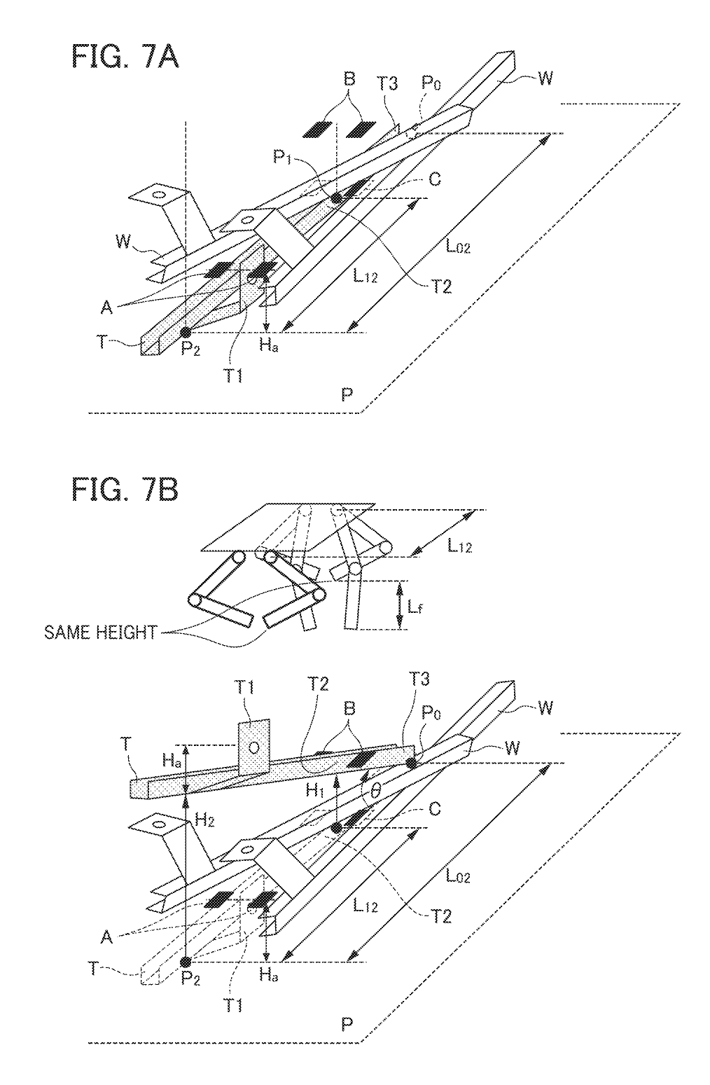

More specifically, this is determined by the judgment as to whether or not there is interference from another reinforcement W at a region A, i.e., a region required to hold the flange portion T1, or at a region C, i.e., a region required to hold the second holding portion T2 (see FIG. 7).

If YES is determined here then determination ends and control proceeds to step ST7. If No is determined then determination continues and control proceeds to step ST4.

In step ST4, it is determined whether or not two step holding is possible for the probe target workpiece corresponding to the domain number i. This is determined similarly based on data of 3-dimensional location and positioning of N reinforcements W recognized in step ST1, and the specific details will be described later.

If YES is determined here, then determination ends and control proceeds to step ST8. If No is determined, then determination continues and control proceeds to step ST5.

In step ST5, it is determined whether or not the domain number i is less than N.

If NO is determined for step ST5, i.e., if i=N, then it is determined that there is no reinforcements W, which can be held, from among N measurable reinforcements W. Thus, determination ends, and control proceeds to step ST9.

If YES is determined for step ST5, i.e., if i<N, then the domain number i is incremented by 1 (i=i+1) in step ST6, control goes back to step ST3 to make determination for the next probe target workpiece corresponding to the domain number i+1, and the processes thereafter are repeated.

In step ST7, the hand 121 and the arm 122 are used for the one step holding and layout.

More specifically, the pair of the first finger F1 and the second finger F2 and the pair of the third finger F3 and the fourth finger F4 hold the reinforcement-to-be-held T corresponding to the domain number i, for which YES is determined in step ST3, at two positions thereof by way of the one step holding, from within the bucket 60 and convey the reinforcement T toward the layout position Wa on the layout surface 151 of the kit platform 15.

As a result of the process of step ST7, the remaining reinforcements W other than the reinforcement-to-be-held T that has been held and set out remain piled up in an untidy heap in the bucket 60, for which the next workpiece holding processing is to be carried out.

In step ST8, the hand 121 and the arm 122 are used for the two step holding and layout. More specifically, the pair of the first finger F1 and the second finger F2 and the pair of the third finger F3 and the fourth finger F4 similarly hold by way of “two step holding” the reinforcement-to-be-held T corresponding to the domain number i, for which YES is determined in step ST4, from within the bucket 60 and convey the reinforcement T toward the layout position Wa on the layout surface 151 of the kit platform 15. More specific details of the “two step holding” will be described later.

As a result of the process of step ST8, the remaining reinforcements W other than the reinforcement-to-be-held T that has been held and set out remain piled up in an untidy heap in the bucket 60, for which the next workpiece holding processing is to be carried out.

In step ST9, the bucket 60 is vibrated by the vibrator 61, and the reinforcements W in an untidy heap contained therein are agitated.

By this agitation, the 3-dimensional positioning of each of the reinforcements W in the untidy heap is changed, and the next workpiece holding processing is carried out for this state.

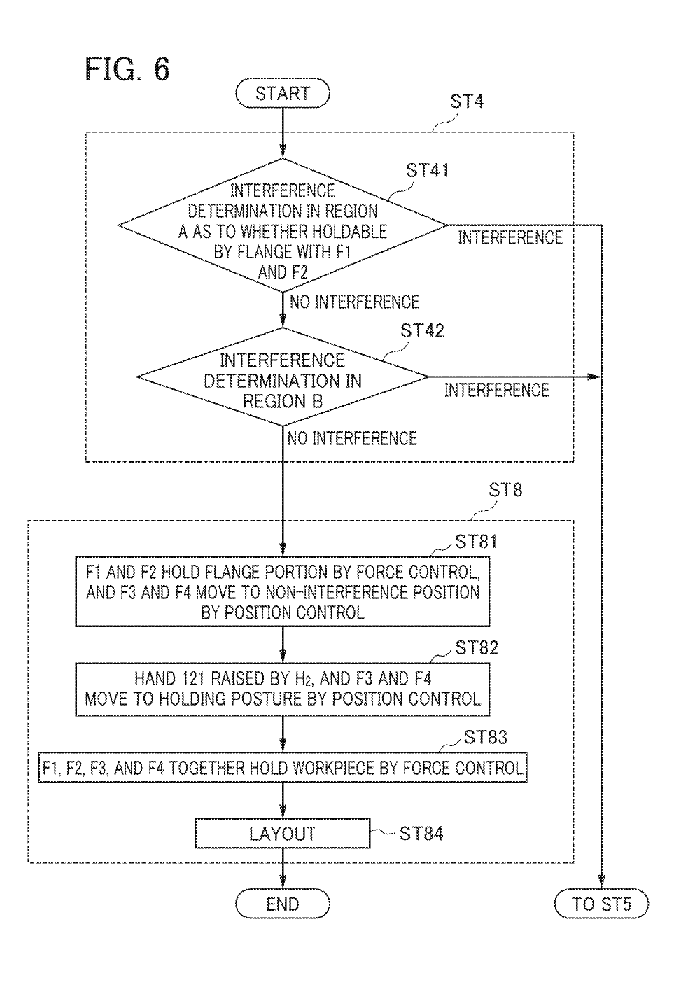

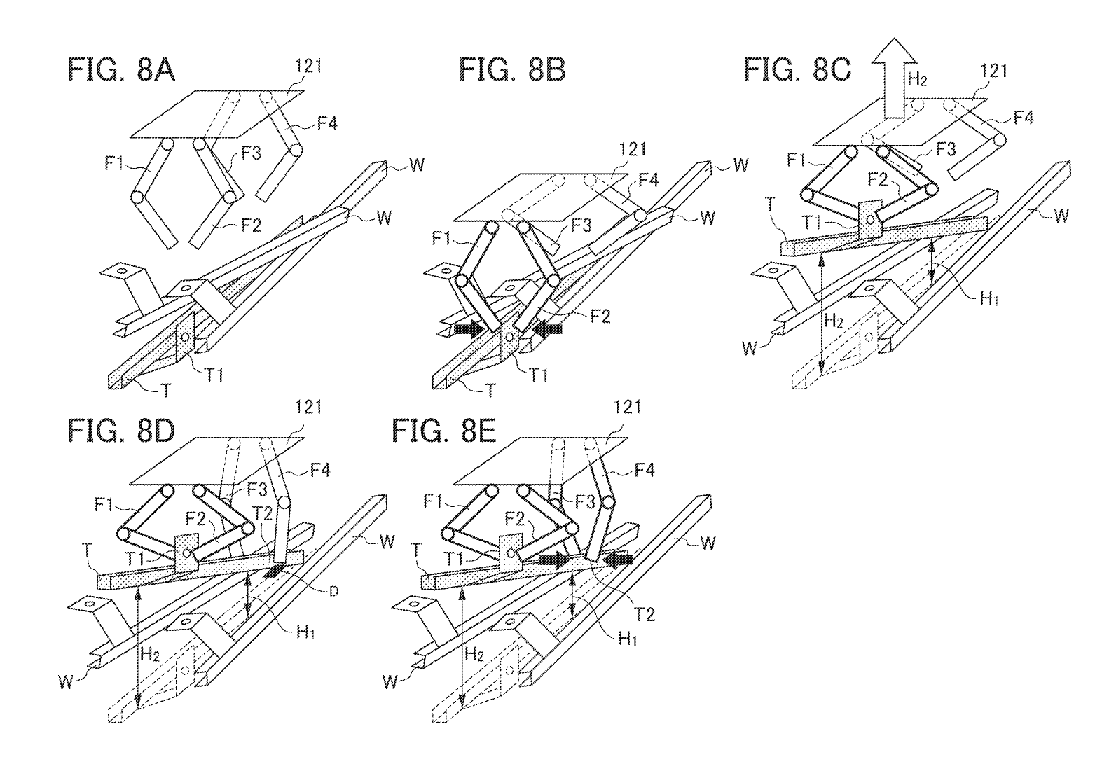

In the following, “two step holding” among workpiece holding operations of the workpiece layout system 1 will be described with reference to FIGS. 6 to 8. FIG. 6 is part of the flowchart of the workpiece holding processing of FIG. 5 showing flow of “two step holding” of a workpiece. FIG. 7A is a view showing a frame format of a state before virtually lifting the workpiece in “two step holding”. FIG. 7B is a view showing a frame format of a state after virtually lifting a workpiece in “two step holding”. FIG. 8 is a set of views respectively showing a frame format of a series of actions in “two step holding”.

The determination in step ST4 of FIG. 5 is, more specifically, made in two steps shown in FIG. 6 as follows: in step ST41, whether or not the flange portion T1 is holdable with the first finger F1 and the second finger F2 (i.e., no interference in the region A), and in step ST42, whether or not the flange portion T2 is holdable with the third finger F3 and the fourth finger F4 when the flange portion T1 is virtually lifted up (i.e., no interference in the region B).

If the determination is “holdable” (i.e., “no interference”) in both of steps ST41 and ST42, then YES is determined for step ST4, determination ends, and control proceeds to step ST8. If the determination is “not holdable” (i.e., “some interference”) in at least one of steps ST41 and ST42, then NO is determined for step ST4, determination continues, and control proceeds to step ST5.

In the following, details of determination in steps ST41 and ST42 will be described with reference to FIG. 7.

As described above, FIG. 7A is a view showing a frame format of a state before virtually lifting a workpiece in “two step holding”. FIG. 7B is a view showing a frame format of a state after virtually lifting a workpiece in “two step holding”.

As described above, the reinforcement-to-be-held T is assigned in order to distinguish the probe target workpiece (a reinforcement W corresponding to the domain number i) from other reinforcements W. Therefore, if the domain number is incremented, the reinforcement-to-be-held T is reassigned to a reinforcement W corresponding to the modified domain number.

Here, definitions will be given as follows:

P indicates an imaginary plane including an elongated part of the reinforcement-to-be-held T, which is elongated in a predetermined direction.

P0 indicates the distal end T3 (pivotal center) of the reinforcement-to-be-held T.

P1 indicates the second holding portion T2 (position of the reinforcement-to-be-held T to be held by the third finger F3 and the fourth finger F4).

P2 indicates a position of the elongated part of the reinforcement-to-be-held T at which the flange portion T1 (to be held by the first finger F1 and the second finger F2) corresponds to the elongated part.

L02 indicates a distance between P0 and P2.

L12 indicates a distance between P1 and P2.

θ indicates an angle formed between the reinforcement-to-be-held T and the imaginary plane P.

H1 indicates a height of P1 from the imaginary plane P when the reinforcement-to-be-held T is lifted.

H2 indicates a height of P2 from the imaginary plane P when the reinforcement-to-be-held T is lifted.

Ha indicates a height of the flange portion T1 from the imaginary plane P when the reinforcement-to-be-held T is not lifted.

Lf indicates an extendable distance from the initial positioning of the third finger F3 and the fourth finger F4 (the same height as the first finger F1 and the second finger F2 when the first finger F1 and the second finger F2 hold the workpiece).

When the workpiece, i.e., the reinforcement-to-be-held T, is lifted up to a virtual position, it is possible to hold the second holding portion T2 if the following equation is satisfied:

H2+Ha=H1+Lf (1)

Based on geometrical relation, the following equation is required to be satisfied.

H1=(L02−L12)(H2/L02) (2)

Substituting the equation (2) into the equation (1), the following equation is acquired.

H2=(L02−L12)(H2/L02)+Lf−Ha

Therefore,

H2=(L02/L12)(Lf−Ha) (3)

Substituting this equation (3) into (2), the following equation is acquired.

H1=((L02−L12)/L12)(Lf−Ha)

Thus, the following equations are acquired.

Height of the region A: Ha

Height of the region B: ((L02−L12)/L12)(Lf−Ha)

Lift of the hand 121 (upward displacement of the flange portion T1): (L02/L12)(Lf−Ha)

In the following, details of determination in steps ST41 and ST42 will be described based on the arithmetic result obtained in the above.

Firstly, since the first finger F1 and the second finger F2 of the hand 121 of the workpiece layout system 1 are assumed to hold the reinforcement-to-be-held T by the flange portion T1, it is determined in step ST41 whether or not the flange portion T1 is holdable with the first finger F1 and the second finger F2 (i.e., no interference at the region A) as described above. This means that the presence or absence of interference of another reinforcement W at the region A, which is a region for holding the flange portion T1, is determined based on the data of 3-dimensional location and positioning of each of the reinforcements W. The height of the region A from the imaginary plane P is Ha, which is the height of the flange portion T1 from the imaginary plane P.

Here, if the determination is “holdable” (“no interference”), then control proceeds to the next step ST4. If the determination is “not holdable” (“some interference”), then control proceeds to step ST5.

Next, since the third finger F3 and the fourth finger F4 of the workpiece layout system 1 are assumed to hold the second holding portion T2, which is at an intermediate point between the flange portion T1 and the opposite end portion T3 of the reinforcement-to-be-held T, it is determined in step ST42 whether or not the second holding portion T2 is holdable with the third finger F3 and the fourth finger F4 when the flange portion is virtually lifted (i.e., no interference at the region B) as described above. This means that the presence or absence of interference from another reinforcement W at the region B, which is a region for holding the second holding portion T2, when the flange portion T1 is virtually lifted by a predetermined amount (H2) is determined based on the data of 3-dimensional location and positioning of each of the reinforcements W.

Here, using H2, which is the virtual height of lifting the flange portion T1 (which is a position at which the workpiece is to be held by the first finger F1 and the second finger F2), the height H1 of the region B from the imaginary plane P is expressed as follows:

H1=(L02−L12)(H2/L02)

Alternatively, using Lf, which is the extendable distance of the third finger F3 and the fourth finger F4 from the initial posture thereof, H1 is expressed as follows:

H1=((L02−L12)/L12)(Lf−Ha)

Here, data used in the determination whether or not the second holding portion T2 is holdable (i.e., no interference at the region B) in the state where the reinforcement-to-be-held T that is the probe target workpiece is virtually lifted, is the data of 3-dimensional location and positioning of other reinforcements W outside of the reinforcement-to-be-held T before the reinforcement-to-be-held T is lifted.

If the determination is “holdable” (“no interference at the region B”) here, it is supposed that there will be no interference with any other reinforcements W at a region D (see FIG. 8D), which is a region for holding the second holding portion T2 of the reinforcement-to-be-held T, which is the probe-target workpiece, when the flange portion T1 of the reinforcement-to-be-held T is actually lifted by the height H2. Therefore, it is determined that “two step holding” is possible, and control proceeds to step ST8.

If, on the other hand, the determination is “not holdable” (“some interference at the region B”), then control proceeds to step ST5.

The process of step ST8 of FIG. 5 is more specifically carried out by a series of processes of steps ST81 to ST84 shown in FIG. 6.

In step ST81, the workpiece layout system 1 moves (lowers) the hand 121 via the arm 122 to a position such that the flange portion T1 of the reinforcement-to-be-held T falls within the reachable range of the first finger F1 and the second finger F2 (see FIGS. 8A and 8B) and then causes the first finger F1 and the second finger F2 to hold the flange portion T1 of the reinforcement-to-be-held T by way of the force control (see FIG. 8B).

As described above, the force control is carried out by generating a position correction amount based on the force information (magnitude and direction of force) detected by each of the force sensors F16 and F26 provided to the respective tips of the first finger F1 and the second finger F2 and the target force instruction of each finger, and adding the position correction amount to the target position instruction of each finger to acquire the tracking target position. For example, when the force detected by the force sensor F16 of the first finger F1 is less than the target force instruction, a position correction amount is calculated that makes the first finger F1 exert extra force so that the force detected by the force sensor F16 reaches the target force instruction. The force control is then carried out by way of feedback control of the servo motors M11 to M14 of the first finger F1 targeting the tracking target position, which is calculated by adding the position correction amount.

At this time, the workpiece layout system 1 withdraws (raises) the third finger F3 and the fourth finger F4 by way of position control so that the third finger F3 and the fourth finger F4 will not interfere with the reinforcement-to-be-held T and the other reinforcements W.

In step ST82, the workpiece layout system I lifts the hand 121 by H2 (see FIG. 8C) via the arm 122 in a state in which the first finger F1 and the second finger F2 are holding the reinforcement-to-be-held T by the flange portion T1 and the third finger F3 and the fourth finger F4 are withdrawn. As a result of this, the reinforcement-to-be-held T is lifted by H2 at the position of the flange portion T1 (unilateral holding process).

With one end of the reinforcement-to-be-held T being lifted, the reinforcement W that has been interfering with the reinforcement-to-be-held T is slid off or edged out and the second holding portion T2 (at a position at which the workpiece is held by the pair of the third finger F3 and the fourth finger F4) is lifted to the height H1 from the imaginary plane P described above, and becomes free of any interference from other reinforcements W.

Furthermore, the workpiece layout system 1 moves the third finger F3 and the fourth finger F4 toward the region D, which is a region for holding the second holding portion T2, by way of position control (see FIG. 8D).

In step ST83, the workpiece layout system 1 causes the third finger F3 and the fourth finger F4 to hold the second holding portion T2 of the reinforcement-to-be-held T by way of force control (bilateral holding process).

Similarly to step ST81, the force control is carried out by generating a position correction amount based on the force information (magnitude and direction of force) detected by each of the force sensors F36 and F46 provided to the respective tips of the third finger F3 and the fourth finger F4 and the target force instruction of each finger, and by adding the position correction amount to the target position instruction of each finger to acquire the tracking target position.

In step ST83, since the first finger F1 and the second finger F2 have been already holding the reinforcement-to-be-held T by the flange portion T1 by way of force control, all of the fingers F1 to F4 are now holding the workpiece by way of force control at this stage (see FIG. 8E).

In step ST84, the workpiece layout system 1 conveys the reinforcement-to-be-held T toward the layout position Wa assigned thereto on the layout surface 151 of the kit platform 15, while adjusting the extension amount of each of the third finger F3 and the fourth finger F4.

Here, the height H2 (lifting height of the flange portion T1 of the reinforcement-to-be-held T) can be set as appropriate so that the aforesaid equation (1) is satisfied.

H₂Ha=H₁+L_{f} (1).

However, the higher the height H2 is set, the higher the height H1 (height of the second holding portion T2 (at which the workpiece is held by the pair of the third finger F3 and the fourth finger F4) from the imaginary plane P) becomes, and the higher the success rate of holding becomes. Thus, it becomes possible to reduce the need for agitating the workpieces by the vibrator 61 and possible to cut back idle running time of the workpiece layout system 1 to restart the workpiece holding operation in the case in which holding is impossible.

The method of setting H2 may be carried out by methods such as, for example, firstly setting H2 to a large value, and then decreasing H2 by a predetermined value (and repeating this process as required) in a case where it is determined that the success rate of holding is higher than a target rate, and increasing H2 by a predetermined value (and repeating this process as required) in a case where it is determined that the success rate of holding is lower than a target rate.

On the other hand, the process time required for “two step holding” of the process of step ST8 (more specifically, the processes of steps ST81 to ST84) becomes shorter as H2 is set lower. Therefore, it is preferable to set the height H2 in consideration of total optimization of the workpiece layout system 1 including a trade-off between enhancement of success rate of holding (reduction of idle running time) and reduction of process time of “two step holding” processing.

In the above, a description has been given of “two step holding” of the reinforcement W from among the workpieces to be set out, i.e., the reinforcement W and the workpieces 602, 604, and 606. However, the target of “two step holding” is not limited to only one type of workpieces to be set out (4 types in the present embodiment), and “two step holding” can be applied similarly to other types (e.g., the workpieces 602 and 604). The type (quantity and shape, for example, whether elongated or not) of workpiece to be set out can be arbitrarily set by adjusting the teaching data.

According to the workpiece holding method of the present embodiment, the following effect can be obtained:

(A) In a case in which a workpiece piled up in an untidy heap is to be held by a multi-fingered hand, even if the target workpiece is subject to interference from another workpiece which has made it impossible to hold the target workpiece by a “one step holding” process, it becomes possible to hold the target workpiece by the “two step holding” processing. Thus, it becomes possible to increase the number of ways of workpiece holding and to enhance the success rate of grasping a workpiece in an untidy heap.

(B) As a result of (A), it becomes possible to reduce idle running time of the workpiece layout system 1 for workpiece agitation and subsequent restarting of workpiece holding processing that is required when holding is impossible, and thereby it is possible to enhance the efficiency of a production process.

(C) The height H2 (lifting height of the flange portion T1 of the reinforcement-to-be-held T), which is a variable affecting characteristics of the “two step holding” processing, can be set as appropriate as long as the equation (1) described above is satisfied.

H₂+Ha=H₁+L_{f} (1).

Therefore, H2 can be set in consideration of a trade-off between enhancement of the success rate of holding (reduction of idle running time of the workpiece layout system 1) and reduction of process time of “two step holding” processing. Thus, total optimization of the workpiece layout system 1 is attainable by setting the height H2 as a control parameter.

(D) The distance L12 between two holding positions can be changed by tilting the pair of the first finger F1 and the second finger F2 toward the pair of the third finger F3 and the fourth finger F4 and/or by tilting the pair of the third finger F3 and the fourth finger F4 toward the pair of the first finger F1 and the second finger F2. Therefore, the “two step holding” can be applied to various workpieces.

(E) Since the distance L12 between two holding positions can be changed as described in (D), the height H1 (height of the second holding portion T2 (at which the workpiece is held by the pair of the third finger F3 and the fourth finger F4) from the imaginary plane P) can be changed according to the aforesaid equation (2) for the same height H2.

H1=(L02−L12)(H2/L02) (2)

Therefore, total optimization of the workpiece layout system 1 is attainable by setting as appropriate the distance L12 between two holding positions as a control parameter.

It should be noted that the present invention is not limited to the embodiment described above, and the invention includes modifications and improvements thereto within a scope in which an object of the present invention is realized. For example, the present invention is applicable to holding and assembling of an elongated workpiece in an assembly system provided to a vehicle body assembly line.

What is claimed is:

1. A workpiece holding method for holding a workpiece-to-be-held by using two holding devices to hold the workpiece in a state in which there is no interference from another workpiece at an insert position of one holding device at which the one holding device is to be inserted to hold the workpiece, the method comprising:
a unilateral holding process of inserting a first holding device at the insert position of the one holding device, to hold and lift the workpiece-to-be-held; and
a bilateral holding process of inserting a second holding device around the workpiece-to-be-held lifted by the first holding device, to hold the workpiece-to-be-held.

2. A workpiece holding method as set forth in claim 1, wherein the workpiece-to-be-held is subject to interference from another workpiece at an insert position at which another holding device is inserted to hold the workpiece-to-be-held.
